(19) United States
(12) Patent Application Publication
(10) Pub. No.: US 2026/0322983 A1
(43) Pub. Date: Oct. 15, 2026

(54) SYSTEMS AND METHODS FOR AUTOMATICALLY CALIBRATING CAMERAS WITHIN CAMERA ARRAYS

(71) Applicant: Visionary Machines Pty Ltd, Sydney, NSW (AU)

(72) Inventor: Rhys Andrew NEWMAN, Sydney (AU)

(21) Appl. No.: 19/150,677

(22) PCT Filed: Jan. 19, 2024
(86) PCT No.: PCT/AU2024/050030

§ 371 Date: Jul. 24, 2025

(30) Foreign Application Priority Data
Jan. 24, 2023 (AU) 2023900169

(51) Int. Cl. H04N 13/246; H04N 13/243

(52) U.S. Cl. CPC H04N 13/246; H04N 13/243

(57) ABSTRACT

The present disclosure is directed to devices, systems and/or methods that may be used for calibrating at least one camera from a camera array that contains at least 3 cameras without requiring independently measured calibration points to be visible in the scene.

### CROSS-REFERENCE

This application claims priority to Australian Provisional Application No. 2023900169, entitled, Systems and Methods for Automatically Calibrating Cameras within Camera Arrays, filed on 24 Jan. 2023, and which is herein incorporated by reference in its entirety.

### FIELD

The present disclosure relates generally to devices, systems and/or methods that may be used for calibrating cameras that are part of an array that consists of at least 3 cameras.

### BACKGROUND

Cameras and arrays of cameras are useful in many applications including, for example, the safe autonomous driving of vehicles, and for example for navigation, surveying, environmental monitoring, crop monitoring, mine surveying, and checking the integrity of built structures. Cameras and camera arrays commonly require calibration before images taken may be used to compute quantitative positions or other processing tasks relating to the 3D scene in view. There are a number of ways to calibrate a camera or array of cameras, often starting by choosing a suitable model of the imaging process together with a calibration scene of known, measured, visible and identified 3D points in the scene (known in the art as “calibration points”). For example, a commonly used model of the imaging process is the “pinhole camera model”, and a commonly used calibration procedure (the Direct Linear Transformation method-DLT) that requires at least six 3D positions to be measured and identified in at least one image taken with each camera that is to be calibrated. Other models that account for non-linear lens distortions which may bend the paths of incoming light as it travels through the optics and is detected on the imaging sensor are also known in the art, and calibration procedures for cameras modelled in this way may be more complex than the DLT method. Nevertheless, even for complex camera models, the calibration process results in a model that reveals from which direction in physical 3D space light from a visible feature in the scene arrives at the camera sensor in order to be detected by at least one pixel sensor thereon.

A common feature of many calibration procedures is the need to have a set of known, measured, visible and identified points in the physical 3D scene (i.e., the calibration points). Because during normal operation these calibration points may not be always present or visible, many camera systems are calibrated once soon after installation and subsequently operate under the assumption the calibration model thus constructed does not change over time. Consequently, if environmental factors or events make a calibration model invalid, for example if one or more cameras are moved relative to the others as a result of damage, vibration or temperature changes, it is likely the system's performance and/or accuracy will degrade.

The present disclosure is directed to automatically calibrating cameras within camera arrays. The present disclosure is also directed to overcome and/or ameliorate at least one or more of the disadvantages of the prior art, as will become apparent from the discussion herein. The present disclosure also provides other advantages and/or improvements as discussed herein.

The Summary which follows is not intended to be limiting as to the embodiments disclosed therein and/or any other embodiments which are disclosed in this specification. In addition, it is envisaged that within its scope, the limitations of one embodiment may be combined with limitations of other embodiments so as to form additional embodiments.

### SUMMARY

At least one embodiment is directed to a system for calibrating a camera within an array of cameras comprising:
at least three cameras;
   wherein the cameras are configured to have an overlapping field of view of a scene;
one or more processors that is configured to:
   capture at least one image from the at least three cameras substantially simultaneously,
   detect image features in at least three of the images captured,
   use the location of these features in at least 2 images to reconstruct their 3D position via stereopsis,
   determine whether at least one of the three cameras has inaccurate calibration based in part on the detected image features and, if so determined,
use the reconstructed 3D positions of the detected features as calibration points to calculate a new calibration for the camera with the inaccurate calibration.

At least one embodiment is directed to a method for calibrating a camera within an array of cameras, the method comprising:
configuring at least three cameras within the array of cameras to have an overlapping field of view of a scene and to be in communication with one or more processors;
capturing at least one image from the at least three cameras substantially simultaneously;
sending the at least one image from the at least three cameras to the one or more processors;
receiving at the one or more processors the captured at least one image from the at least three cameras;
detecting image features in the at least three of the images captured at the one or more processors;
using the location of these features in at least 2 images to reconstruct their 3D position via stereopsis;
determining at the one or more processors whether at least one of the three cameras has inaccurate calibration based in part on the detected image features and, if so determined;
using the reconstructed 3D positions of the detected image features as calibration points with which to calculate a new calibration for the camera with the inaccurate calibration.

Certain embodiments are directed to devices, methods and/or systems comprising: at least three camera sensors; wherein the sensors are configured to capture one or more images of a scene and by suitably cross-referencing the perceived locations of features in those images to recalculate the camera calibration model for at least one of the cameras in the array. This correction procedure of the calibration model(s) may help maintain the accuracy of any measurements or processing tasks performed using the images taken with the camera array over time.

Certain embodiments are directed to methods for determining a camera calibration during normal operation where a known set of 3D calibration points may not be available, using any of the systems disclosed herein.

Certain embodiments are directed to one or more computer-readable non-transitory storage media embodying software that is operable when executed using any of the systems and/or methods disclosed herein.

### BRIEF DESCRIPTION OF DRAWINGS

FIG. 1 shows a camera observing a scene, according to a prior art pinhole camera model.

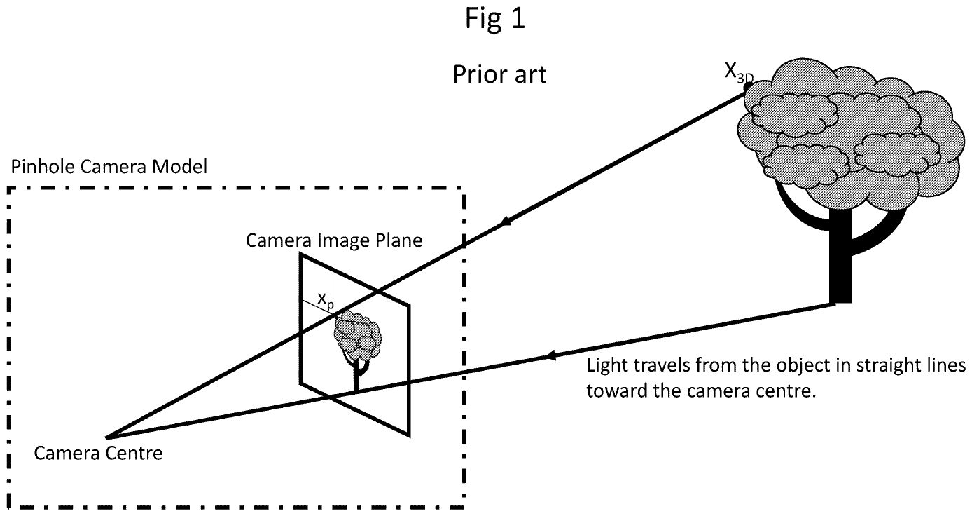

FIG. 2 illustrates a camera array where one camera in a camera array being moved out of alignment by some event (perturbation).

FIG. 3 shows a representation of the process flow, according to at least one embodiment.

FIG. 4 shows how the errors (of the pixel positions of calibration points reprojected from 3D into camera image planes) of a camera array may grow as an exemplary method embodiment herein disclosed is applied repeatedly to repair random camera perturbations.

FIGS. 5A-5K shows non-limiting examples of configurations of camera arrays comprising of three or more cameras, according to at least one embodiment. Other camera configurations are also contemplated.

FIG. 6 illustrates a camera array with 5 cameras, where one camera (640) has been moved out of alignment by some event (perturbation), as shown at 640b; using at least one of the embodiments disclosed to recalibrate the camera 640.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

Certain embodiments of this disclosure may be useful in a number of areas. For example, one or more of the following non-limiting exemplary applications: off-road vehicle (e.g., cars, buses, motorcycles, trucks, tractors, forklifts, cranes, backhoes, bulldozers); road vehicles (e.g., cars, buses, motorcycles, trucks); rail based vehicles (e.g., locomotives); air based vehicles (e.g., airplanes, drones), space based vehicles (e.g., satellites, or constellations of satellites); individuals (e.g., miners, soldiers, war fighters, rescuers, maintenance workers), amphibious vehicles (e.g., boats, cars, buses) ; and watercraft (e.g., ships boats, hovercraft, submarines). In addition, the non-limiting exemplary applications may be operator driven, semi-autonomous and/or autonomous. Further applications may include navigation, autonomous vehicle navigation, surveying, surveillance, reconnaissance, intelligence gathering, environmental monitoring, monitoring difficult to access applications (e.g., inside a nuclear reactor), and infrastructure monitoring.

The term “scene” means a subset of the three dimensional real-world (i.e., 3D physical reality) as perceived through the field of view of one or more cameras or other sensors. In certain embodiments, there may be at least 1, 2, 3, 4, 5, 10, 15, 20, 25, 30, 35 or 40, 100, 1000, or more cameras and or other sensors. In at least one embodiment, the camera array may have between 3 to 6 cameras, between 4 to 8 cameras, between 6 to 12 cameras, between 10 to 18 cameras, between 18 to 24 cameras, or between 24 and 34 cameras. In at least one embodiment, the camera array may have between 30 to 50 cameras, between 50 to 100 cameras, or between 100 to 1000 cameras.

The term “object” means an element in a scene. For example, a scene may include one or more of the following objects: a person, a child, a car, a truck, a crane, a mining truck, a bus, a train, a motorcycle, a wheel, a patch of grass, a bush, a tree, a branch, a leaf, a rock, a hill, a cliff, a river, a road, a marking on the road, a depression in a road surface, a snow flake, a house, an office building, an industrial building, a tower, a bridge, an aqueduct, a bird, a flying bird, a runway, an airplane, a helicopter, door, a door knob, a shelf, a storage rack, a fork lift, a box, a building, an airfield, a town or city, a river, a mountain range, a field, a jungle, and a container. An object may be a moving element or may be stationary or substantially stationary. An object may be considered to be in a background or a foreground.

The term “physical surface” means the surface of an object in a scene that emits and/or reflects electromagnetic signals in at least one portion of the electromagnetic spectrum and where at least a portion of such signals travel across at least a portion of the scene.

The term “3D point” means a representation of the location of a point in the scene defined at least in part by at least three parameters that indicate distance in three dimensions from an origin reference to the point, for example, in three directions from the origin where the directions may be substantially perpendicular (at least not co-planar or co-linear), or as an alternative example using a spherical coordinate system consisting of a radial distance, a polar angle, and an azimuthal angle.

The term “camera” means a device that comprises an image sensor, an optional filter array and a lens (or a plurality of lenses) that at least partially directs a potentially limited portion of incoming electromagnetic signals onto at least some of the sensor elements in an image sensor. The lens, for example, may be a pin hole, an optical lens, a diffractive grating lens or combinations thereof. In certain embodiments a camera may be an imaging device that can image from electromagnetic signals in one or more bands including for example visible, ultraviolet, infra-red, short-wave infra-red (SWIR).

The term “each” as used herein means that at least 95%, 96%, 97%, 98%, 99% or 100% of the items or functions referred to perform as indicated. Exemplary items or functions include, but are not limited to, one or more of the following: location(s), image pair(s), cell(s), pixel(s), pixel location(s), layer(s), element(s), neighbourhood(s), point(s), 3D neighbourhood(s), 3D point(s), and calibration points.

The term “at least a substantial portion” as used herein means that at least 60%, 70%, 80%, 85%, 95%, 96%, 97%, 98%, 99%, or 100% of the items or functions referred to. Exemplary items or functions include, but are not limited to, one or more of the following: location(s), image pair(s), cell(s), pixel(s), pixel location(s), layer(s), element(s), point(s) 3D point(s), and calibration points.

The term “camera calibration” or just “calibration” is a relationship between locations on the camera image plane (for example, pixels in the case of a digital camera) and paths along which light from the scene passes in order to register on the camera imaging sensor at the (pixel) locations.

The term “calibration point” is a 3D location in a scene, known to a suitable level of accuracy that is also visible in one or more camera images and so has a corresponding 2D pixel location(s) on the one or more images.

The term “independently measured calibration point” means a 3D point in the scene whose 3D position has been measured by some manner other than by using information in the images captured with one or more of the cameras in the camera array. For example, such 3D points may be located using a laser measurement device, a LIDAR sensor, or using techniques and equipment employed in surveying services. Such 3D points may be measured at a different time to the time that their location information is used to calibrate a camera in the camera array.

The term “image feature” means a 2D location in an image captured by at least one camera in the camera array.

The term “reconstructed calibration point” means the 3D point whose 3D position is determined from the locations of a scene feature detected in 2 or more images captured by at least 2 of the cameras in the camera array

### Exemplary Flow

There are a number of methods known in the art to estimate, for a given camera and lens combination, the camera calibration parameters. Examples include the standard DLT method, Zhang's method and Tsai's method. The standard DLT method is described, for example, in “Multiple View Geometry in Computer Vision: Second Edition” (by Richard Hartley and Andrew Zisserman, Cambridge University Press, pp 88-93), which is incorporated by reference in its entirety. Zhang's method is described, for example, in “A Flexible New Technique for Camera Calibration” (by Zhengyou Zhang, IEEE Transactions on Pattern Analysis and Machine Intelligence, Volume 22, Issue 11, November 2000pp 1330 -1334) which is incorporated by reference in its entirety. Tsai's method is described for example in “An Efficient and Accurate Camera Calibration Technique for 3D Machine Vision” (by R.Y. Tsai, Proceedings of IEEE Conference on Computer Vision and Pattern Recognition, Miami Beach, FL, 1986, pp364-374) which is incorporated by reference in its entirety.

Some methods start with a camera viewing a scene that has within view a number of calibration points that are in known 3D positions in the scene. However, the requirement to be able to see and identify the 3D positions of calibration points in at least one camera image may be unsuitable in some applications. For example, while wishing to move in a vehicle at speed through the environment it may be undesirable to have to stop, place and measure the location of calibration points in a scene in order to update the calibration of cameras mounted on the vehicle. Equally, in difficult to access industrial applications (e.g., inside a nuclear reactor), it may be difficult to arrange for a camera to view one or more calibration points that are in known 3D locations once installed and operating. In such cases, cameras may be calibrated infrequently, in some cases only once during installation, and at other times the cameras may be required to operate under the assumption the calibration does not vary over time and/or during use. Nevertheless, in many applications, environmental conditions may introduce a range of perturbations (for example, vibrations or physical damage) that may change the relative positions or even internal parameters (for example, the focal length of at least one lens) of one or more cameras in the array, thereby invalidating the calibration of one or more cameras in the array. Consequently, it may be useful to have at least one of the disclosed approaches, as disclosed in at least one embodiment herein, to correct miscalibrations of one or more cameras without requiring them to be able to view a number of independently measured calibration points in the scene.

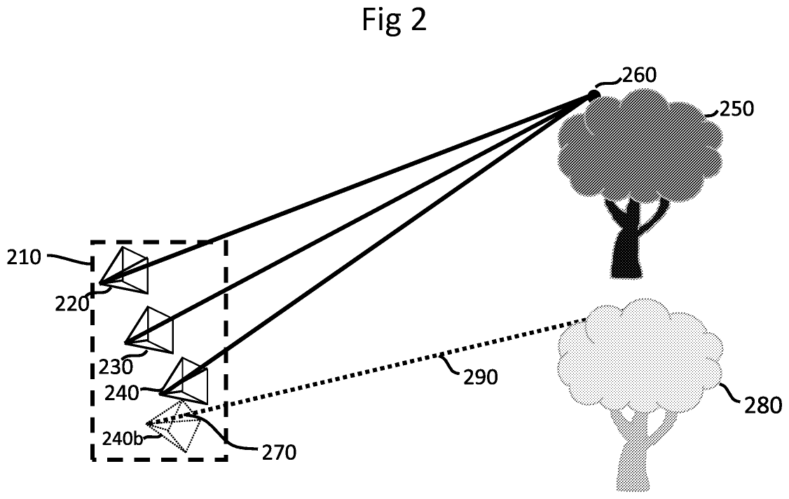

FIG. 2 illustrates a camera array and an illustration of the consequence of one camera in a camera array (240) being moved out of alignment by some event (perturbation) to a pose 240b. Images of elements in the scene, for example, 260 may be in the incorrect position when viewed with the perturbed camera (e.g., along the ray 290) and consequently measurements and/or processing done that include the perturbed camera's image data may be inaccurate.

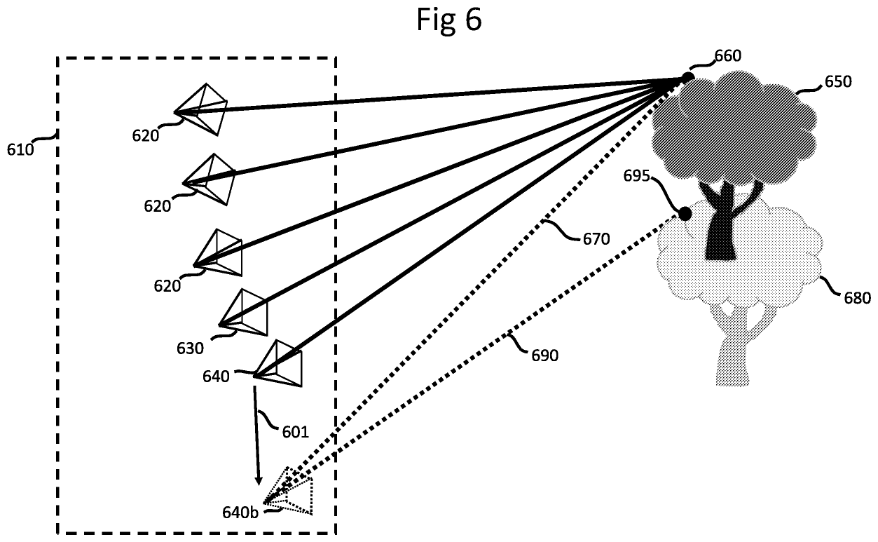

FIG. 6 illustrates a camera array with five cameras, where one camera (640) has been moved out of alignment by some event (perturbation) as shown by 601, resulting in camera 640 moving to 640b. Images of elements in the scene (e.g., 695) may be in the incorrect position when viewed with the perturbed camera (640b). Reconstructing the camera's calibration using the 3D positions of reconstructed calibration points in the scene (e.g., 660) results in camera 640 correctly imaging point 660 along a ray 670 rather than along ray 690 that was the direction in which point 695 was incorrectly perceived by camera 640b after being perturbed (and before being corrected).

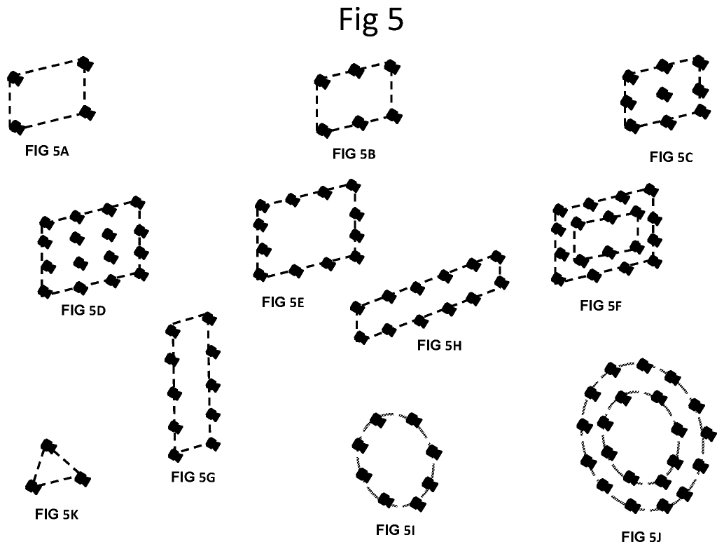

FIGS. 5A-5K shows non-limiting examples of configurations of camera arrays comprising of three or more cameras. Other camera configurations are also contemplated.

FIG. 2 shows a camera array 210. For example, this camera array may be mounted on a moving vehicle and/or arranged in difficult to access applications (e.g., inside a nuclear reactor). In this illustrated camera array, the array comprises three cameras at 220, 230 and 240 where each camera is shown with a representation of the camera image plane thus showing the position and orientation of the camera in the scene. A scene represented by the image of a tree 250 is observed by the cameras 220, 230 and 240. Where the camera calibration of a camera in the camera array is known then a 3D point in the scene such as at 260 may be mapped to a corresponding 2D point in the image plane of the respective camera. However, at 240b is illustrated a perturbed camera where the mapping is no longer correct. A point 270 on that camera's image plane, before perturbation, was an image of the top of the tree 260. However, that ray after perturbation follows the line 290 which shows camera 240b now sees the tree in the scene at a phantom position 280 rather than at the correct position 250.

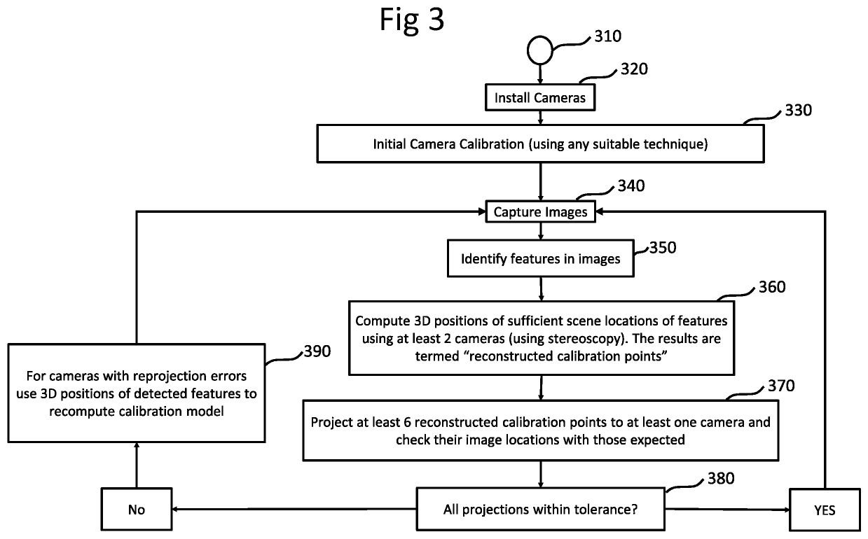

An exemplary embodiment of the process of calibrating one or more cameras in a camera array without needing any independently measured calibration points in view is illustrated in FIG. 3. Starting from 310 cameras are installed as a camera array at 320. At 330 the cameras (such as 220, 230, and 240) in the camera array 210 are calibrated by using a suitable method, for example, the method known in the art as DLT, the method of Zhang or the method of Tsai. The process moves to step 340 and the camera array 210 then proceeds to operate as required, capturing images at whatever rate is desired. The captured images are then transferred to one or more processors for further processing (not shown in FIG. 3). The one or more processors may be located within the array, located adjacent the camera array, or other suitable arrangements may be used. For example, the processing may take place in the camera array, adjacent to the camera array, remote to the camera array, or combinations thereof. The communication between the cameras in the camera array may be direct and/or indirect.

At step 350 image features in the captured images may be identified using one or more feature detectors which may take place at a processor configured with a suitable feature detector. Suitable feature detectors may be, for example, the Harris Corner detector (as described in “A Combined Corner and Edge Detector”, by Chris Harris and Mike Stephens in Alvey Vision Conference. Vol. 15, 1988 which is incorporated by reference in its entirety), SIFT features (described for example in “Object recognition from local scale-invariant features”, by David Lowe in Proceedings of the International Conference on Computer Vision. Vol. 2. 1999, pp. 1150-1157, which is incorporated by reference in its entirety), SURF features (for example, as described in “SURF: Speeded Up Robust Features” by Herbert Bay, Andreas Ess, Tinne Tuytelaars, Luc Van Gool, in Computer Vision and Image Understanding (CVIU), Vol. 110, No. 3, 2008, pp. 346--359), and other suitable feature detectors, or a novel feature detector. Image features thus selected are cross-referenced between images captured by the cameras so that those that represent the same point in the scene are labelled and/or identified in at least two of the images in which they appear. In the example illustrated by FIG. 2, there are three cameras in the array so cross-referenced images captured by two cameras may be used. In other larger camera arrays, the system may use more cross-referenced images from more cameras. For example, in the five-camera array, illustrated in FIG. 6, the system may use at least three or four cross-referenced images captured by the cameras. Using stereopsis, the 3D locations of these image features may be then computed at step 360 using one or more processors configured to perform step 360. At step 370 at least some of these 3D points are then judged to be accurate enough to be used as calibration points (termed reconstructed calibration points) which are then re-projected to the imaging plane of at least one of the cameras in the array, using the calibration currently in place for the at least one camera. In this exemplary embodiment, step 370 may be performed using the calibration that had been constructed using the DLT method. A camera that has suffered perturbation may now be detected as one where the reprojected position of at least one of the 3D points is at variance with the position of that calibration point's associated image feature as detected in that camera's image. A suitable error tolerance threshold, for example, a reprojection error of 10, 1, 0.1 or 0.01 pixels, may be used to decide whether to proceed with the process of recalibrating a particular camera (step 380). In at least one embodiment, the reprojection error may be at least 0.01, 0.1, 1, 10 pixels to trigger recalibration. In at least one embodiment, the reprojection error may be between 0.001 and 0.01, between 0.01 and 0.1, between 0.1 and 1, or between 1 and 10 pixels. If recalibration is decided upon, then at step 390 the reconstructed calibration points determined by in step 360, together with the 2D projection of their associated image features in the image taken by the camera to be recalibrated, may be used to determine a new calibration for that camera using one or more processors configured to perform step 390. There are various methods known in the art to do this calibration, for example, the Direct Linear Transformation method (DLT), the method of Zhang or the method of Tsai.

The above exemplary embodiment permits cameras to be recalibrated while operating without use of independently measured calibration points in the scene. In this example, the requirement is that at least two non-perturbed cameras and at least one perturbed camera sees at least the required number of reconstructed calibration points in the scene for the selected calibration procedure to operate. For example, if the calibration process is the DLT method, then at least six reconstructed calibration points may be recommended or required, for Zhang's method more than twenty calibration points may be recommended or required, and for Tsai's method over 100 reconstructed calibration points may be recommended or required. The number of reconstructed calibration points required may be between 6 and 12, between 12 and 18, between 18 and 24, between 24 and 50, or between 50 and 100. The number of reconstructed calibration points required may be at least 4, 5, 6, 10, 16 20, 30, 50, 100 or 1000 points.

The exemplary embodiments described herein may be applied at suitable times during operation when a suitable quality and number of reconstructed calibration points in the scene are visible in 3 or more cameras. The disclosed exemplary recalibrations may be performed multiple times, substantially continuously, or continuously during operation of the camera array. For a camera array that captures multiple image frames from at least 3 of its cameras substantially synchronously, the exemplary recalibrations described herein may be performed every frame, every second frame, every third frame or only on selected frames during operation according to the selected triggering criteria. Such triggering criteria may include the absolute time according to some time measurement source, the elapsed time since a specified event occurred or was detected, the elapsed time since the last recalibration procedure, a rate or an approximate rate over time, whenever a significant reprojection error is detected by examining the images captured from time to time from one or more cameras in the array, as instructed by some external command, or combinations thereof.

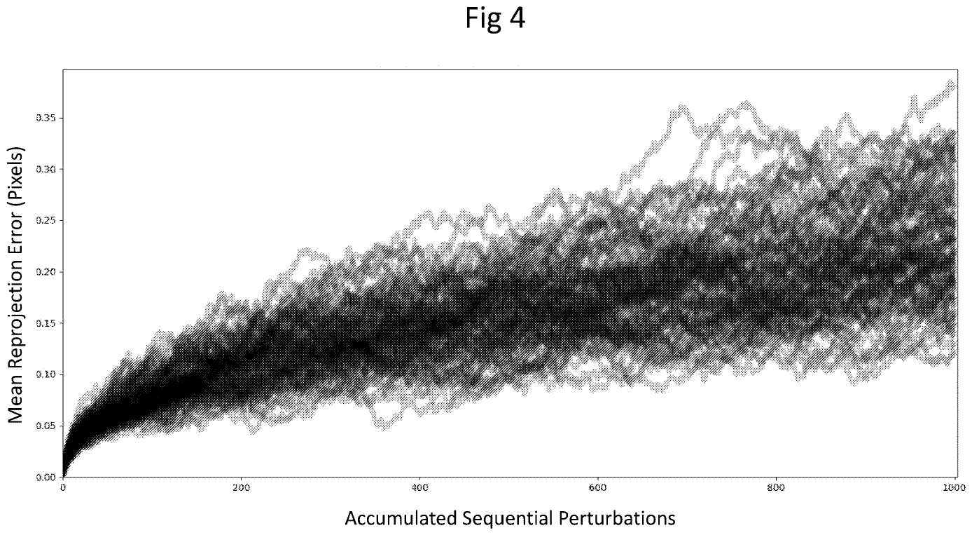

FIG. 4 shows the cumulative effect of applying an exemplary recalibration process, using the technique described herein, to a camera array that is repeatedly perturbed. At each successive perturbation (represented on the X axis-- the number of perturbations) a random perturbation is applied to a randomly selected camera in a camera array with 8 cameras (in this example). The Y axis shows the mean absolute reprojection error of the set of the selected calibration points in the scene, i.e., the pixel difference in each camera's image of the projected position of the selected calibration point in the scene and its actual position identified in each respective camera's image. The overall pixel reprojection error grows in a way that may be described as a classical random walk, but the results of this experiment using an exemplary implementation demonstrates that at least one of the exemplary embodiments disclosed herein is able to keep this overall error down to less than 0.35 pixels even after 1000 random perturbations to the cameras in the array.

In addition to other advantages disclosed herein, one or more of the following advantages may be present in at least one embodiment.

One advantage may be that a camera array that is subject to perturbations is able to automatically correct calibration errors using images captured during normal operation and not necessarily by viewing a scene with independently measured calibration points identified therein.

Another advantage may be that in applications where calibration after initial installation is impractical or impossible, this technique may be used to maintain a systems' acceptable level of performance in the face of perturbations.

Another advantage is that this method is not especially sensitive to the amount of perturbation introduced to the cameras in the array. Once a camera is detected as perturbed, its new calibration may be calculated without reference to its previous calibration and therefore even if substantial and/or permanent damage has occurred to the array, the camera array may still remain operational to an acceptable level of performance.

Further advantages of the claimed subject matter will become apparent from the following examples describing certain embodiments of the claimed subject matter.

1. A system for calibrating a camera within an array of cameras comprising:
at least three cameras;
wherein the cameras are configured to have an overlapping field of view of a scene; one or more processors that is configured to:
capture at least one image from the at least three cameras substantially simultaneously,
detect image features in at least three of the images captured, use the location of these features in at least 2 images to reconstruct their 3D position via stereopsis,
determine whether at least one of the three cameras has inaccurate calibration based in part on the detected image features, and if so determined, use the reconstructed 3D positions of the detected features as calibration points to calculate a new calibration for the camera with the inaccurate calibration.

2. The system of example 1, wherein the method used for calibrating the camera is the Direct Linear Transform method.

3. The system of examples 1 or 2, wherein at least six image features are detected in each, or a substantial portion, of the at least three images captured.

4. The system of any of examples 1 to 3, wherein the system is configured to recalibrate the camera in the camera array in real-time.

5. The system of any of examples 1 to 4, wherein the system is configured to recalibrate the camera in the camera array in real-time, if inaccurate calibration is determined for the camera.

6. The system of any of examples 1 to 5, wherein the system is configured to repeat the recalibration process for the at least three cameras in the camera array in real time.

7. The system of any of examples 1 to 6, wherein the system is configured to automatically correct calibration the at least three cameras in the camera array using the at least three of the images captured while the system is in operation.

8. The system of any of examples 1 to 7, wherein the system is configured to automatically correct calibration in the at least three cameras in the camera array using the at least three of the images captured during operation of the system without resorting to the use of independently measured calibration points.

9. The system of any of examples 1 to 8, wherein the system is configured to automatically correct calibration in the at least three cameras in the camera array using the at least three of the images captured during operation of the system without reference to a previous calibration.

10. The system of any of examples 1 to 9, wherein the camera array has between 3 to 6 cameras, between 4 to 8 cameras, between 6 to 12 cameras, between 10 to 18 cameras, between 18 to 24 cameras, or between 24 and 34 cameras.

11. The system of any of examples 1 to 10, wherein the method used for calibrating the camera is the Zhang's method.

12. The system of any of examples 1 to 11, wherein the method used for calibrating the camera is the Tsai's method.

13. The system of any of examples 1 to 12, wherein an error tolerance threshold of a reprojection error of between 0.001 and 0.01, between 0.01 and 0.1, between 0.1 and 1, or between 1 and 10 pixels is used to decide whether to proceed with recalibrating at least one camera in the camera array.

14. The system of any of examples 1 to 13, wherein the number of calibration points required is between 6 and 12, between 12 and 18, between 18 and 24, between 24 and 50, or between 50 and 100.

15. A method for calibrating a camera within an array of cameras, the method comprising:
configuring at least three cameras within the array of cameras to have an overlapping field of view of a scene and to be in communication with one or more processors:
capturing at least one image from the at least three cameras substantially simultaneously; sending the at least one image from the at least three cameras to the one or more processors;
receiving at the one or more processors the captured at least one image from the at least three cameras;
detecting image features in the at least three of the images captured at the one or more processors;
using the location of these features in at least 2 images to reconstruct their 3D position via stereopsis;
determining at the one or more processors whether at least one of the three cameras has inaccurate calibration based in part on the detected image features and, if so determined;
using the reconstructed 3D positions of the detected image features as calibration points with which to calculate a new calibration for the camera with the inaccurate calibration.

16. The method of example 15, wherein the method for calibrating the camera is the Direct Linear Transform method.

17. The method of examples 15 or 16, wherein at least six image features are detected in each, or a substantial portion, of the at least three images captured.

18. The method of any of examples 15 to 17, wherein the method is configured to recalibrate the camera in the camera array in real-time.

19. The method of any of examples 15 to 18, wherein the method is configured to recalibrate the camera in the camera array in real-time, if inaccurate calibration is determined for the camera.

20. The method of any of examples 15 to 19, wherein the method is configured to repeat the recalibration process for the at least three cameras in the camera array in real time.

21. The method of any of examples 15 to 20, wherein the method is configured to automatically correct calibration the at least three cameras in the camera array using the at least three of the images captured while the method is in operation.

22. The method of any of examples 15 to 21, wherein the method is configured to automatically correct calibration in the at least three cameras in the camera array using the at least three of the images captured during operation of the method without resorting to the use of independently measured calibration points.

23. The method of any of examples 15 to 22, wherein the method is configured to automatically correct calibration in the at least three cameras in the camera array using the at least three of the images captured during operation of the method without reference to a previous calibration.

24. The method of any of examples 15 to 23, wherein the camera array has between 3 to 6 cameras, between 4 to 8 cameras, between 6 to 12 cameras, between 10 to 18 cameras, between 18 to 24 cameras, or between 24 and 34 cameras.

25. The method of any of examples 15 to 24, wherein the method used for calibrating the camera is the Zhang's method.

26. The method of any of examples 15 to 25, wherein the method used for calibrating the camera is the Tsai's method.

27. The method of any of examples 15 to 26, wherein an error tolerance threshold of a reprojection error of between 0.001 and 0.01, between 0.01 and 0.1, between 0.1 and 1, or between 1 and 10 pixels is used to decide whether to proceed with recalibrating at least one camera in the camera array.

28. The method of any of examples 15 to 27, wherein the number of calibration points required is between 6 and 12, between 12 and 18, between 18 and 24, between 24 and 50, or between 50 and 100.

29. One or more computer-readable non-transitory storage media embodying software that is operable when executed using any of the systems or methods in examples 1 to 28.

Any description of prior art documents herein, or statements herein derived from or based on those documents, is not an admission that the documents or derived statements are part of the common general knowledge of the relevant art.

While certain embodiments have been shown and described herein, it will be obvious to those skilled in the art that such embodiments are provided by way of example only.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It is to be understood that the present disclosure is not limited to the disclosed embodiments, and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

1-29. (canceled)

30. A system for calibrating a camera within a camera array, the system comprising:
at least three cameras, wherein the cameras are configured to have an overlapping field of view of a scene; and
one or more processors that is configured to:
capture at least one image from the at least three cameras substantially simultaneously;
detect image features in at least three of the images captured;
use a location of these features in at least two images to reconstruct their 3D position via stereopsis; and
determine whether at least one of the three cameras has inaccurate calibration based in part on the detected image features and, if so determined,
use the reconstructed 3D positions of the detected image features as calibration points to calculate a new calibration for the camera with the inaccurate calibration.

31. The system of claim 30, wherein a method used for calibrating the camera is Direct Linear Transform method.

32. The system of claim 30, wherein at least six image features are detected in each, or a substantial portion, of the at least three images captured.

33. The system of claim 30, wherein the system is configured to recalibrate the camera in the camera array in real-time and optionally if inaccurate calibration is determined for the camera.

34. The system of claim 33, wherein the system is configured to repeat recalibration process for the at least three cameras in the camera array in real time.

35. The system of claim 30, wherein the system is configured to automatically correct calibration in the at least three cameras in the camera array using any one of:
the at least three of the images captured while the system is in operation;
the at least three of the images captured during operation of the system without resorting to the use of independently measured calibration points; or
the at least three of the images captured during operation of the system without reference to a previous calibration.

36. The system of claim 30, wherein the camera array has between 3 to 6 cameras, or between 4 to 8 cameras, or between 6 to 12 cameras, or between 10 to 18 cameras, or between 18 to 24 cameras, or between 24 and 34 cameras.

37. The system of any claim 30, wherein a method used for calibrating the camera is any one of: Zhang's method or Tsai's method.

38. The system of claim 30, wherein an error tolerance threshold of a reprojection error of between 0.001 and 0.01, or between 0.01 and 0.1, or between 0.1 and 1, or between 1 and 10 pixels, is used to decide whether to proceed with recalibrating at least one camera in the camera array.

39. The system of claim 30, wherein a number of calibration points required is between 6 and 12, or between 12 and 18, or between 18 and 24, or between 24 and 50, or between 50 and 100.

40. A method for calibrating a camera within a camera array, the method comprising:
configuring at least three cameras within the camera array to have an overlapping field of view of a scene and to be in communication with one or more processors;
capturing at least one image from the at least three cameras substantially simultaneously;
sending the at least one image from the at least three cameras to the one or more processors;
receiving at the one or more processors the captured at least one image from the at least three cameras;
detecting image features in the at least three of the images captured at the one or more processors;
using a location of the image features in at least two images to reconstruct their 3D position via stereopsis; and
determining at the one or more processors whether at least one of the three cameras has inaccurate calibration based in part on the detected image features and, if so determined,
using the reconstructed 3D positions of the detected image features as calibration points with which to calculate a new calibration for the camera with the inaccurate calibration.

41. The method of claim 40, wherein the method for calibrating the camera is a Direct Linear Transform method.

42. The method of claim 40, wherein at least six image features are detected in each, or a substantial portion, of the at least three images captured.

43. The method of claim 40, further comprising recalibrating the camera in the camera array in real-time and optionally, if inaccurate calibration is determined for the camera.

44. The method of claim 43, wherein the method is configured to repeat recalibration process for the at least three cameras in the camera array in real time.

45. The method of claim 40, further comprising automatically correcting calibration in the at least three cameras in the camera array using any one of:
the at least three of the images captured while the method is in operation;
the at least three of the images captured during operation of the method without resorting to the use of independently measured calibration points; or
the at least three of the images captured during operation of the method without reference to a previous calibration.

46. The method of claim 40, wherein the camera array has between 3 to 6cameras, or between 4 to 8 cameras, or between 6 to 12 cameras, or between 10 to 18 cameras, or between 18 to 24 cameras, or between 24 and 34 cameras.

47. The method of claim 40, wherein the method used for calibrating the camera is any one of: Zhang's method or Tsai's method.

48. The method of claim 40, wherein an error tolerance threshold of a reprojection error of between 0.001 and 0.01, or between 0.01 and 0.1, or between 0.1 and 1, or between 1 and 10 pixels, is used to decide whether to proceed with recalibrating at least one camera in the camera array.

49. The method of claim 40, wherein a number of calibration points required is between 6 and 12, or between 12 and 18, or between 18 and 24, or between 24 and 50, or between 50 and 100.

50. One or more computer-readable non-transitory storage media embodying software that, when executed by a processor, performs the method of claim 40.
